(19) United States
(12) Patent Application Publication
(10) Pub. No.: US 2003/0075837 A1
(43) Pub. Date: Apr. 24, 2003

(54) Method and apparatus for injection moulding plastics material

(76) Inventors: Matthew Emmett Sayer, Buckinghamshire (GB); Kenneth Richard Crow, Birmingham (GB)

Correspondence Address: Smith Gambrell & Russell, Suite 800, 1850 M Street NW, Washington, DC, 20036, US

(21) Appl. No.: 10/275,106

(22) PCT Filed: Apr. 25, 2001
(86) PCT No.: PCT/GB01/01839

(51) Int. Cl. B29C 45/17

(52) U.S. Cl. 264/500; 425/130; 425/577; 425/556; 264/572

(57) ABSTRACT

The invention provides a method and apparatus for injection moulding a plastics article having thin and thick wall sections (14; 15). A quantity of molten plastics material (19) is introduced sufficient to fill the mould cavity, followed by a further quantity of molten plastics material sufficient to pack at least the portion or portions of the mould cavity in which the thin wall section or sections (14) are formed. Pressurized fluid is introduced through the or each fluid injection member to penetrate the plastics material whereby a fluid-filled void (20) is formed within the plastics material adjacent to the inner end of the fluid injecting member, and fluid pressure is maintained within the or each void so that the void expands in response to the shrinkage of the immediately surrounding plastics material, during cooling, until the plastics material is self-supporting.

This invention relates to a method and apparatus for injection moulding plastics material to manufacture articles having thin and thick wall sections.

Articles having thick wall sections, e.g. bosses, at selected positions which are of increased thickness relative to the general wall thickness, are subject to sink marks occurring in the surface of the thick wall sections and/or distortion of the article. The sink marks occur due to the shrinkage of the plastics material during cooling within the mould before the thick wall sections are self-supporting. Distortion occurs as a result of residual stress.

To try to counteract sink marks it is known to overfill the mould cavity by packing the cavity with additional plastics material as the plastics cools. However, this can only be partially successful since as soon as the plastics cools in a thin wall section it may block further plastics entering a thick wall section beyond the thin wall section which requires further plastics material as the plastics cools in the thick wall section.

The same happens when the plastics entry gate freezes, thereby preventing any further plastics material entering the mould cavity. Consequently, sink marks may result during subsequent cooling of the plastics material.

European Patent No. 0495614 discloses an injection moulding method for plastics' articles having thick and thin wall portions in which at least one void inducing member is provided for the or each thick wall portion. The void inducing member has an acute tip at one end which is located in the mould cavity. Subsequent to filling the mould cavity with molten plastics material, compressed gas, e.g. air, is fed along the periphery of the void inducing member to the acute tip at which point the gas penetrates the plastics material to induce a-void nucleus in the molten plastics. Cooling and solidifying the plastics material causes the void nucleus to expand in response to volumetric shrinkage of the surrounding plastics material.

According to the invention there is provided a method of injection moulding a plastics article-having thin and thick wall sections by employing a mould having a mould cavity corresponding to the shape of the article, and the mould having at least one fluid injection member extending into a portion of the mould cavity in or adjacent to the area in which a thick wall section is to be formed, the method comprising:

introducing a quantity of molten plastics material sufficient to fill the mould cavity;

introducing a further quantity of molten plastics material sufficient to pack at least the portion or portions of the mould cavity in which the thin wall or section or sections are formed so that the or each thin wall section is self-supporting;

injecting pressurised fluid through the or each fluid injection member to penetrate the plastics material surrounding the inner end of the fluid injecting member whereby a fluid-filled void is formed within the plastics material adjacent to the inner end of the fluid injecting member; and

maintaining fluid pressure within the or each void so that the void expands in response to the shrinkage of the immediately surrounding plastics material, during cooling, until the plastics material is self-supporting.

The fluid is preferably vented from the or each void before the mould is opened to remove the article.

Preferably during the step of maintaining fluid pressure within the or each void, the pressurised fluid within the respective void is maintained at its initial injection pressure.

The pressurized fluid is preferably a gas, e.g. compressed air.

It is also preferred that the fluid pressure is not more than 55 bar.

The invention also provides an apparatus for injection moulding a plastics article having thin and thick wall sections, comprising:

a mould having a mould cavity corresponding to the shape of the article;

at least one fluid injection member extending into a portion of the mould cavity in or adjacent to the area in which a thick wall section is to be formed with its inner end positioned at a required locality within the mould cavity;

means for injecting molten plastics material into the mould cavity both to fill the mould cavity and to pack at least the portion or portions of the mould cavity in which the thin wall section or sections are formed so that the or each thin wall section is self-supporting; and

means for injecting pressurised fluid through the or each fluid injecting member to penetrate the plastics material surrounding the inner end of the fluid injection member for forming a fluid-filled void within the plastics material adjacent to the inner end of the fluid injection member, and to maintain fluid pressure within the void as it expands in response to the shrinkage of the immediately surrounding plastics material, during cooling, until the plastics material is self-supporting.

Preferably, means are provided for enabling the or each fluid-filled void to be vented before the mould is opened to remove the article.

Preferably the fluid injection member has an outer sleeve mounted in the wall of the mould, and an inner member permitting fluid to be injected into the mould cavity through a clearance gap between the inner member and the outer sleeve.

It is also preferred that the inner member has a tip at its inner end over which the pressurised fluid is passed to assist the fluid to penetrate the skin of the surrounding plastics material. Preferably the tip of the inner member has an inclusive acute angle of not more than 40°.

The fluid injection nozzle may be combined with a core pin, and/or an ejector pin.

By way of example, specific embodiments in accordance with the invention will be described with reference to the accompanying drawings in which:—

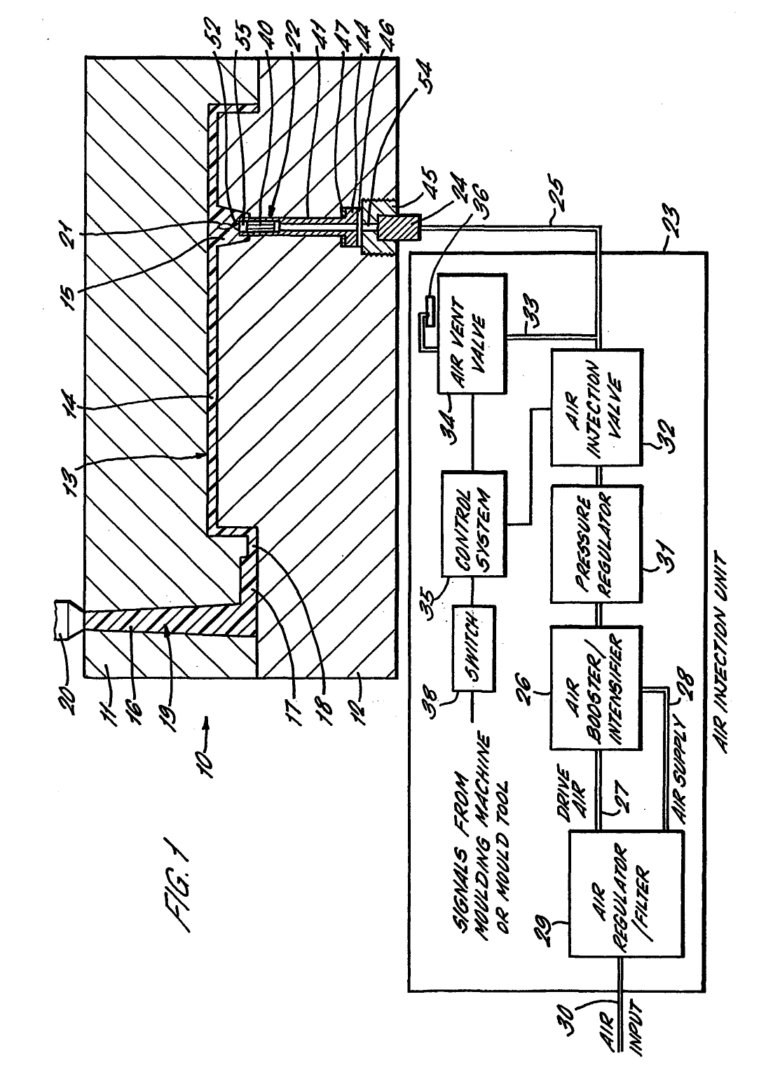

FIG. 1 illustrates a system for injection moulding a plastics article employing a first embodiment of a fluid injection nozzle to form a void in a thick wall section of the article;

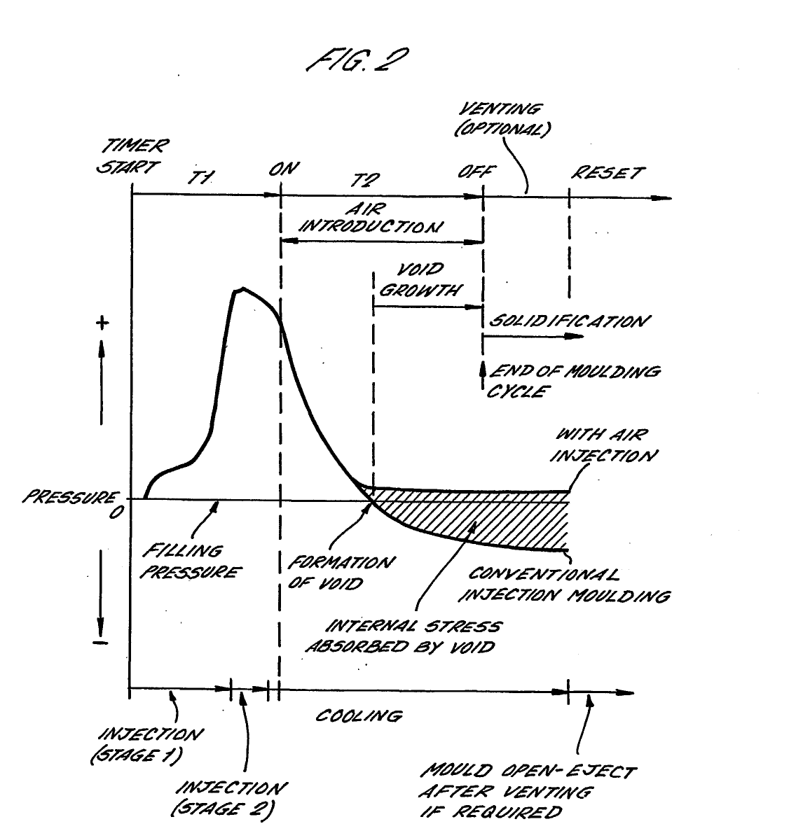

FIG. 2 is a graph showing the plastics pressure during the injection of the plastics and the formation of the void;

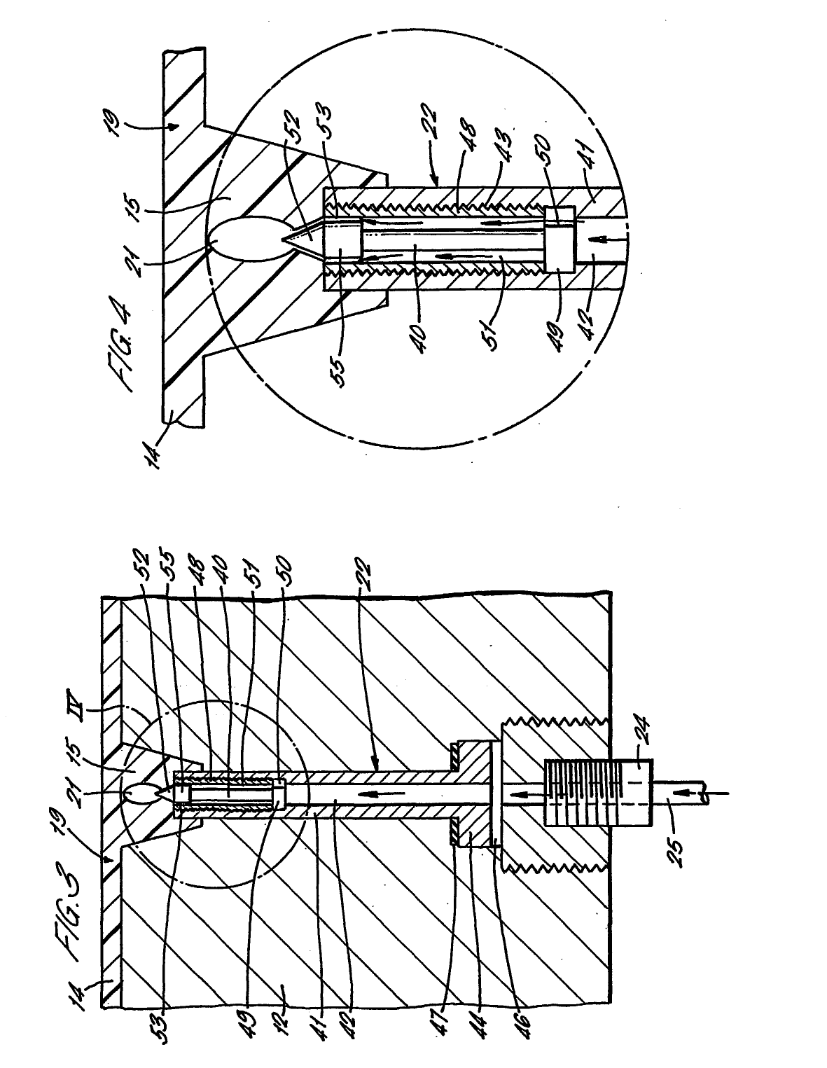

FIG. 3 is a longitudinal section of the fluid injection nozzle of FIG. 1, which is also a core pin, the nozzle extending into the portion of the mould cavity in which the thick wall section is to be formed;

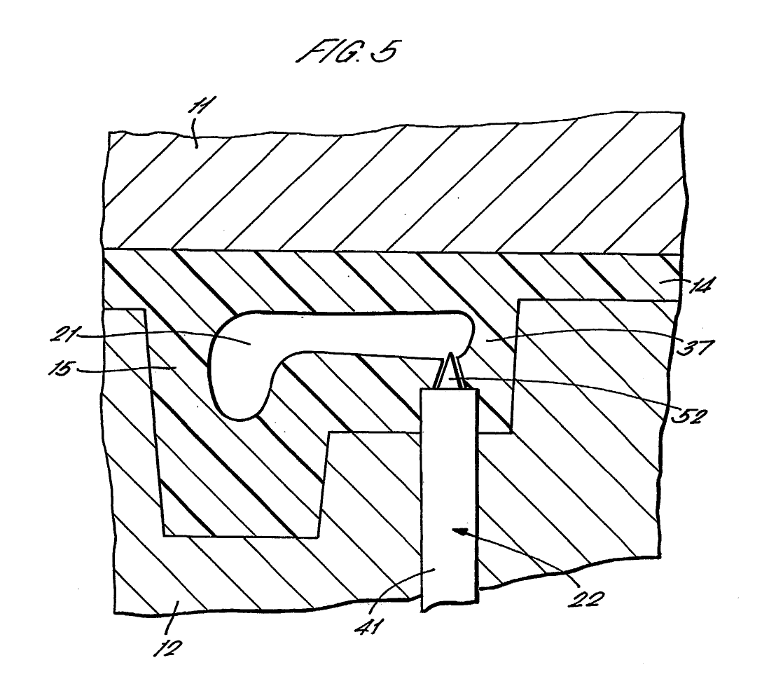

FIG. 4 is an enlarged view of detail IV in FIG. 3 of the nozzle pin of the fluid injection nozzle;

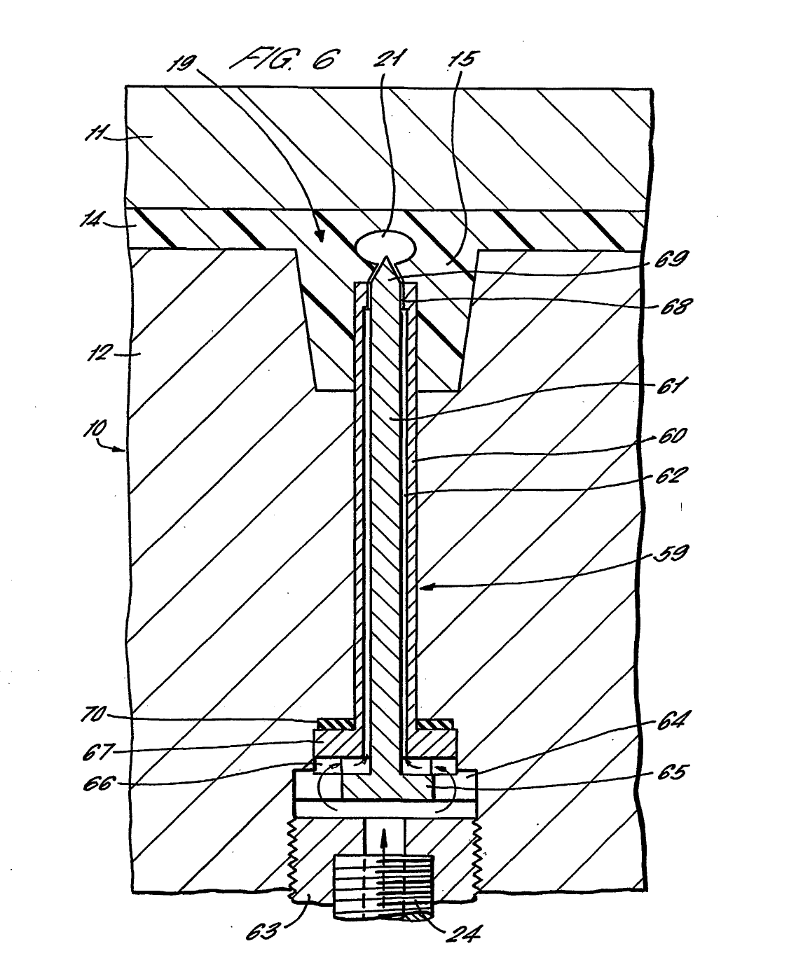

FIG. 5 shows the fluid injection nozzle of FIG. 1 positioned in a portion of the mould cavity which is adjacent the area in which the thick wall section is to be formed;

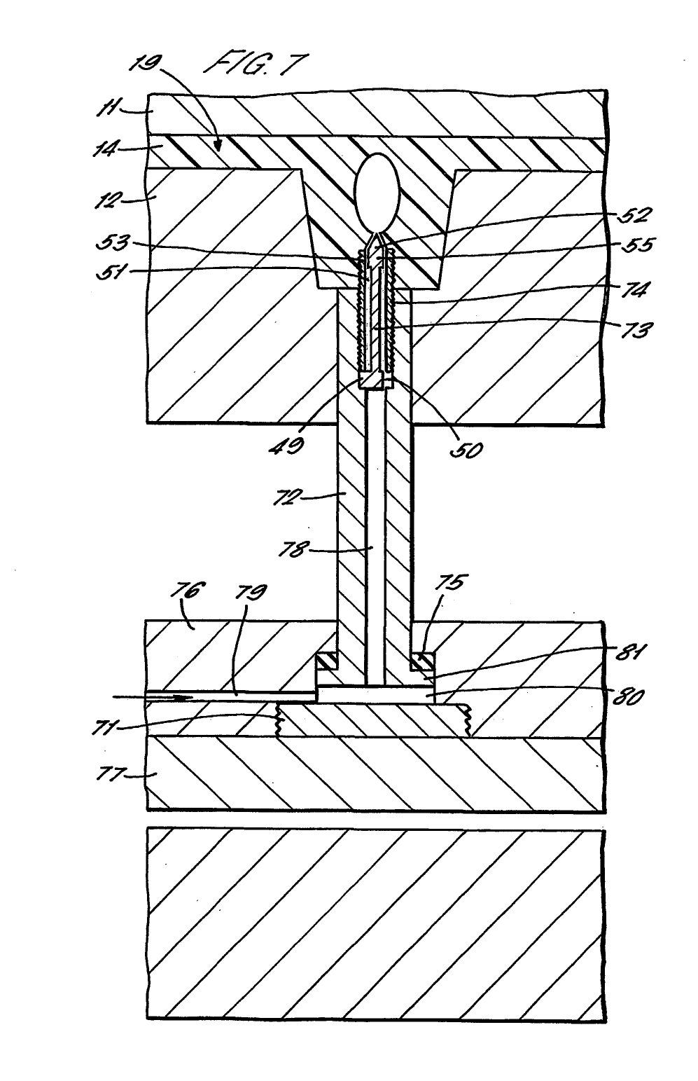

FIG. 6 shows a second embodiment of a fluid injection nozzle including a nozzle pin and outer sleeve;

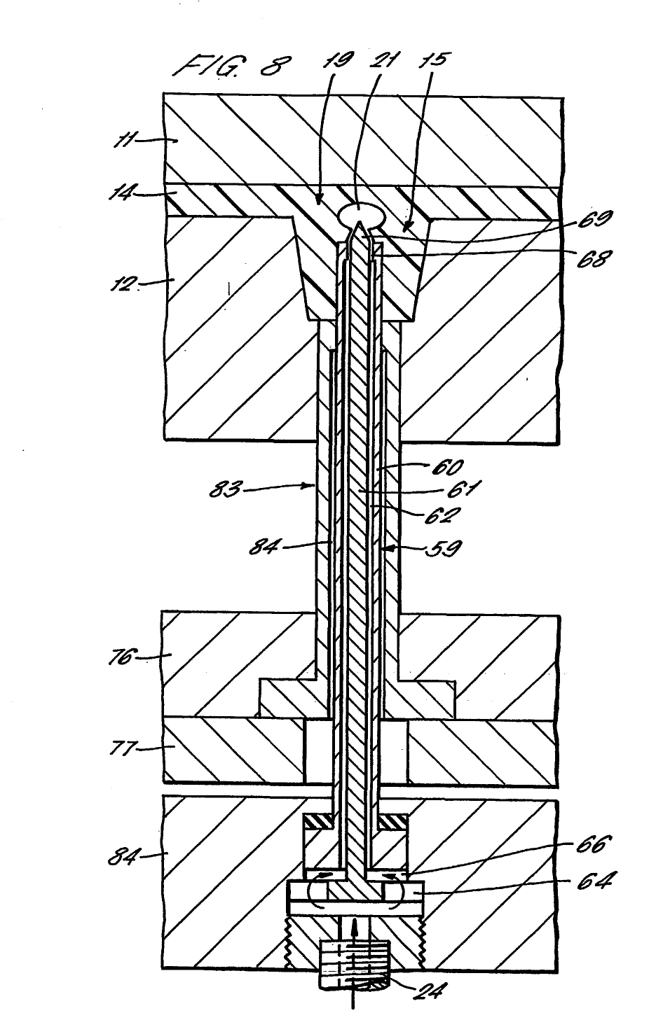

FIG. 7 shows a third embodiment of a fluid injection nozzle having the nozzle pin mounted in an ejector pin;

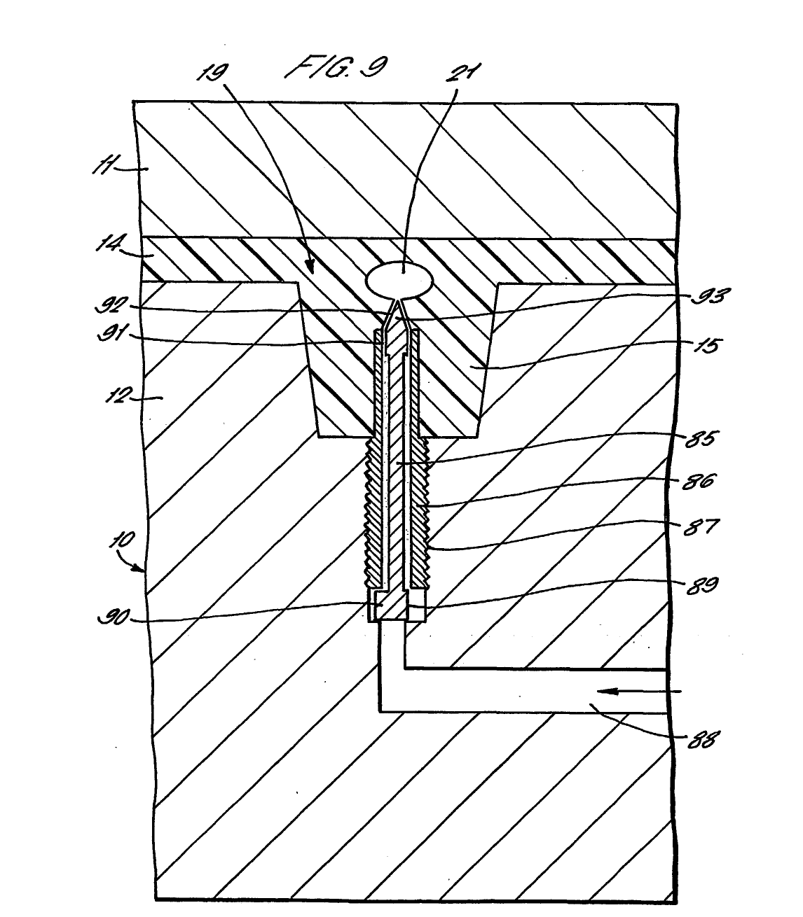

FIG. 8 shows a fourth embodiment of a fluid injection nozzle incorporating the nozzle pin and sleeve of FIG. 3 within a sleeve ejector;

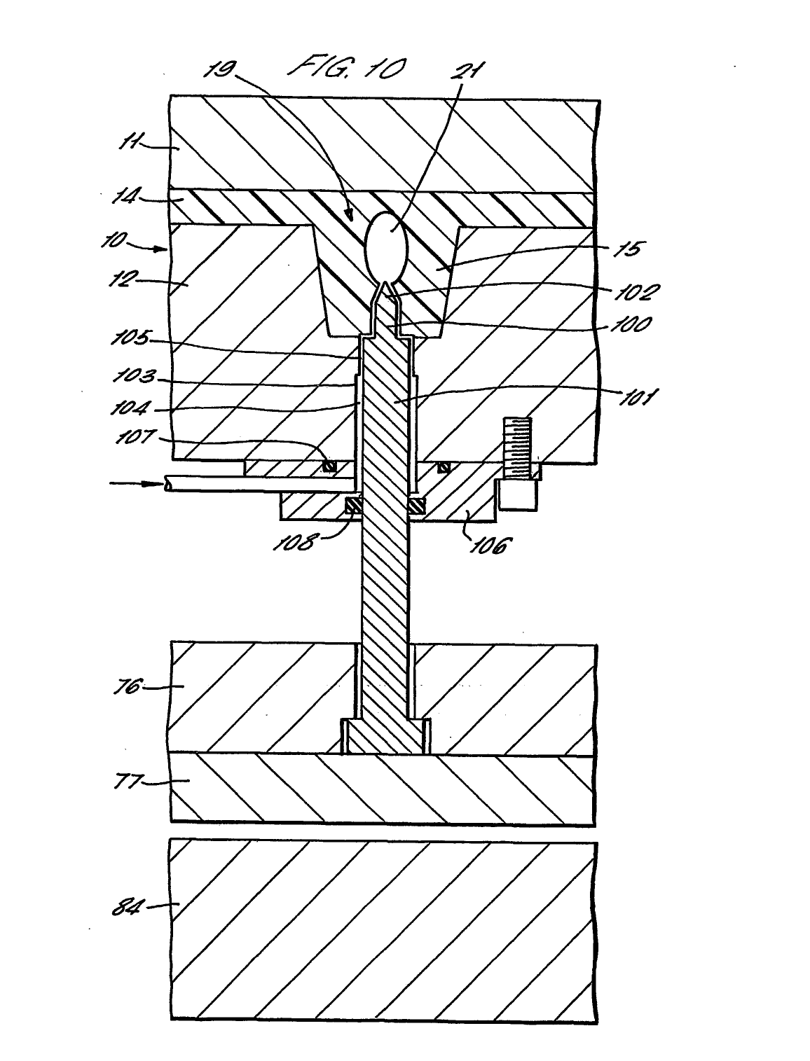

FIG. 9 shows a fifth embodiment of a fluid injection nozzle having a nozzle pin mounted directly into the mould tool; and

FIG. 10 shows a sixth embodiment of a fluid injection nozzle comprising a combined nozzle pin and ejector pin and a fluid path along the periphery of the nozzle.

This example concerns a process and apparatus for injection moulding molten plastics material to manufacture articles having thin and thick wall sections. One object of the process is to inhibit noticeable sink marks on a surface of the or each thick wall section. Another object is to minimise any distortion of the article caused by residual stress.

For this purpose, a void is formed internally in the or each thick wall section at the required locality, and is caused or allowed to expand so that the total volume of the voids corresponds to the volumetric shrinkage of the injected plastics material, during cooling.

As described below, this process is applicable to mouldings in which a mould cavity, having at least one thin wall section and at least one thick wall section, is filled and pre-packed with molten plastics material from a moulding machine, at least in the thin wall section or sections so that the or each thin wall section is self-supporting. Generally a pressurised fluid, e.g. compressed air, at no more than 55 bar, in this embodiment, is injected adjacent to or directly into the or each thick wall section where a high degree of shrinkage occurs. The fluid forms a small void or bubble, thereby packing or further packing the plastics material above the bubble and eliminating the potential sink mark. The void also minimises resultant stress and thereby inhibits distortion of the article. The void is first formed when the pressure of the molten plastics in the locality of the fluid injection nozzle falls below the fluid pressure being applied. The size of the void is resultant upon a relationship between the fluid pressure, the extent of pre-packing and the volumetric shrinkage of the plastics material. Appropriate timers within the fluid injection unit are triggered in the correct sequence in relation to the moulding machine cycle. In this embodiment, fluid pressure in the or each void is then vented to atmosphere or to a reclamation chamber, before the mould is opened to remove the article. Alternatively, for some articles, because the air pressure is low, the volume of the void is small and the wall thickness in the thick wall section is relatively thick, it may be possible to eliminate the venting step without risking rupture of the article when the mould is opened.

The following description is directed towards the injection of compressed air as the pressurised fluid. However, the system includes the possibility of injecting other pressurised gas, e.g. nitrogen, instead of compressed air. It is also possible to inject a liquid, e.g. water or a liquid blowing agent, under pressure instead of pressurised gas.

FIG. 1 shows a mould tool 10 having upper and lower mould parts 11, 12 defining a mould cavity 13 therebetween. The mould cavity-defines the shape of an article having thin wall sections 14 and at least one thick wall section 15. Within the upper mould part 11, there is a resin flow path comprising a sprue 16, runner 17 and gate 18 for molten plastics material 19 to be introduced from the injection nozzle 20 of a moulding machine into the mould cavity 13.

Within the or each thick wall section 15 where it is required to form a fluid-filled void 21, there is provided the inner end of a fluid injection member or nozzle 22 connected, in this embodiment, to an air injection unit 23. As indicated above, the air injection unit may be adapted for supplying a fluid, e.g. nitrogen or water or a liquid blowing agent, under pressure, instead of compressed air.

The air injection nozzle 22 is mounted in the lower part 12 of the mould tool and connected via a fitting 24 and conduit 25 to the air injection unit 23. The unit 23 includes a conventional air booster or intensifier 26 having a large diameter piston supplied with drive air to drive a small diameter piston. The drive air 27 and air supply 28 to the small piston are delivered through an air regulator or filter 29 on the supply side of the intensifier 26, from an air inlet 30.

On the pressure side of the air intensifier 26 is a pressure regulator 31 which is set to limit the pressure of the air fed through an air injection valve 32 to conduit 25. A branch line 33 downstream of valve 32 has an air vent valve 34 to atmosphere or a reclamation chamber 36, for venting air in a controlled manner from the void 21, if required. Both valves 32, 34 are controlled by a control system 35 which receives signals from the moulding machine or the mould tool 10. The signal can be obtained by a switch 38 fitted to the moulding machine or the mould tool 10. The switch 38 may be a proximity switch or other switch which is actuated as the mould tool 10 closes, if the switch is on the mould tool, or as the plastics material 19 is injected, if the switch is on the moulding machine.

Referring to FIGS. 1 and 2, an amount of molten plastics material 19 is introduced along the resin flow path from the injection nozzle 20 of the moulding machine to fill the mould cavity 13 (Injection Stage 1), during which the plastics pressure rises as shown. This is followed by the injection of a further amount of the molten plastics material (Injection Stage 2) along the resin flow path to pack at least the thin wall sections 14 until the thin wall sections are self-supporting, and preferably partially pack the or each thick wall section 15 of the mould cavity 13. During this second injection stage, the plastics pressure begins to fall. After a delay time set by timer T1, the filling of the mould cavity is complete. With air vent valve 34 closed, air injection valve 32 is opened and the air injection unit 23 delivers compressed air at the pressure determined by pressure regulator 31 via the or each fluid injection nozzle 22 to the required locality in the respective thick wall section 15 of the mould cavity 13, for the period set by timer T2. When the plastics pressure adjacent the inner end of the fluid injection nozzle 22 falls below the applied air pressure, a fluid-filled void 21 begins to form in the plastics material. The air pressure is maintained at the pressure determined by pressure regulator 31, by the air intensifier 26, as the volume of the fluid-filled void 21 increases during the cooling of the plastics material in the thick wall section until the plastics material is self-supporting. On solidification of the plastics material in the mould cavity, the internal or residual stress is absorbed by the void. The air injection valve 32 is then closed and, if required, the air vent valve 34 is opened so that air in the void 21 is vented back through the fluid injection nozzle to atmosphere, in a controlled manner, until the air pressure in the void is reduced to atmospheric pressure. The mould is opened and the article is removed using ejector pins. The apparatus is then reset ready for the next moulding cycle.

In the graph of FIG. 2, the shaded area is defined by an upper line which represents the plastics pressure in the present embodiment during the formation of the void and shows that the plastics pressure remains above zero until after venting. This positive pressure is required to support the void 21 and present sinkage on the surface of the plastics material. The lower line of the shaded area is representative of the plastics pressure in conventional injection moulding in which the pressure would fall below zero during the cooling stage, i.e. below that pressure which is required to prevent sinkage.

FIG. 2 also indicates that the venting stage is optional since the fluid pressure employed is low, the volume of the void is small and the wall thickness in the thick wall section is relatively thick.

If more than one fluid injection nozzle 22 is employed, the nozzles can be linked by a manifold between the air supply conduit 25 from the air injection unit 23 and the fitting 24 for each nozzle. Likewise, if the fluid injected is a gas other than air, or a liquid, e.g. water or a liquid blowing agent, suitable supply means will be provided for feeding the gas or liquid under pressure to the or each nozzle 22, and for subsequently venting the fluid, if required.

In an alternative embodiment, the air injection valve 32 may be opened earlier than described above, i.e. at any time after the nozzle 22 is covered with plastics material. The fluid is then available to enter the plastics material to form the void 21 as soon as the plastics pressure adjacent the inner end of the nozzle falls below the applied pressure of the fluid.

As illustrated in FIGS. 1, 3 and 4, the fluid injection nozzle 22 in the lower part 12 of the mould tool 10 has a nozzle pin 40 in combination with a nozzle body 41 which, in this embodiment, is also a core pin. The nozzle body 41 projects into the thick wall section 15 of the mould cavity 13 and has a through hole 42 with a counterbore 43 at its inner end. At the outer end of the nozzle body is a head 44 and the nozzle body is held in the mould tool by a plug 45, which in this embodiment is screw threaded into the mould tool. The fluid supply fitting 24 fits into the plug 45 which has an aperture 54 aligned with the through hole 42 in the nozzle body 41. The head 44 also has a transverse slot 46 to allow fluid to be fed laterally, if desired, through an aligned hole drilled through the mould tool to the underside of the nozzle body, instead of through the fitting 24. A seal 47 is provided between the head of the nozzle body and the mould tool. In this embodiment, the seal 47 is a flat washer, but the seal may be an O-ring or other sealing means.

The counterbore 43 has an internal thread to receive a screw-threaded sleeve 48 for the nozzle pin 40. The nozzle pin has a head 49 at its inner end by which the nozzle pin 40 is held captive in the sleeve 48. One or more slots 50 in the head 49 connect the through hole 42 in the core pin with an annular passage 51 between the shank of the nozzle pin 40 and the sleeve 48. The outer end portion 55 of the nozzle pin 40 is a clearance fit in the sleeve 48, and has a protruding tip 52 which acts as a void inducing member. The clearance fit provides a gap 53 which allows the air to exit therethrough and to flow in one or more streams over part or all of the peripheral surface of the tip 52, i.e. beneath the plastics material 19 surrounding-the tip, but is sufficiently narrow to preclude the back flow of plastics material which would block the gap during filling and/or packing of the mould cavity. The tip 52 of the pin 40 is pointed and, in this embodiment, has an inclusive acute angle of not more than 400, the tip acting to focus the flow of air so that it enters the plastics material to form an initial void which expands as the surrounding plastics material contracts during cooling. If a greater angle of tip were to be used, the air might tend to flow on the outside of the article without penetrating the plastics material to form a void.

In FIG. 5, the fluid injection nozzle 22 is positioned in a portion 37 of the mould cavity 13 which is adjacent to the thick wall section 15 in which the void 21 is to be formed. In this embodiment, the portion 37 defines a wall section of intermediate thickness between the adjacent area of the thin wall section 14 and the adjacent area of the thick wall section 15. Otherwise, the fluid injection nozzle 22 is constructed and operates in the same manner as the nozzle of FIGS. 1, 3 and 4. The void 21 which is formed extends from the tip 52 of the nozzle 22 in the intermediate wall section 37 to the required locality in the thick wall section 15.

FIG. 6 shows an alternative embodiment of fluid injection nozzle 59 comprising an outer sleeve 60 which acts as a core pin, and an inner nozzle pin 61 with an annular passage 62 therebetween. As before, the nozzle 59 is held in the lower mould part 12 by a screwed plug 63. Intercommunicating slots 64, 66 in a head 65 of the pin 61 and a head 67 of the sleeve 60 respectively, are provided to allow the air to flow to the passage 62 from an air supply fitting 24, or through a hole drilled in the lower part 12 of the mould tool.

A flat washer 70 is provided as sealing means between the head 67 of the outer sleeve 60 and the mould tool.

FIG. 7 shows a further embodiment of fluid injection nozzle comprising a combined ejector pin 72 and nozzle pin 73. The inner end of the nozzle is equivalent to the nozzle of FIG. 4, except that the nozzle pin 73 and mounting sleeve 74 extend beyond the end of the ejector pin 72 into the plastics material 19 in the mould cavity 13. The length of the nozzle pin 73 and the sleeve 74 depends on the thickness of the plastics material in the thick wall portion 15. Sealing means is provided by a flat washer 75 or O-ring between the head of the ejector pin 72 and ejector plate 76. A screwed or sealing plug 71 is provided between the ejector plate 76 and a capping plate 77. Air is provided to the through hole 78 in the ejector pin 72 via a fitting mounted in the capping plate or, as shown, through a transverse hole 79 drilled in the ejector plate 76. A slot 80 in the head 81 of the ejector pin 72 allows air to flow through the hole 79 to the nozzle pin 73.

FIG. 8 relates to an embodiment of fluid injection nozzle which combines the nozzle 59 of FIG. 6 and a sleeve ejector 83. Air is injected through a fitting in back plate 84 and slots 64, 66 into the passage 62 between the nozzle pin 61 and sleeve 60. The air then flows through the clearance gap 68 and over the peripheral surface of the protruding tip 69. An annular passage 84 between the sleeve 60 and the sleeve ejector 83 allows the ejector sleeve to move upwardly relative to the nozzle 59 to eject the article when the mould tool 10 is opened.

Instead of combining the nozzle with a core pin or ejector pin, a nozzle pin 85 and threaded sleeve 86 may be screwed directly into a tapped hole 87 in the lower part 11 of the mould tool 10, as illustrated in FIG. 9. Compressed air, or other fluid, e.g. nitrogen or water, under pressure is supplied to the nozzle pin 85 and sleeve 86 through a transverse hole 88 drilled in the lower part 12 of mould tool 10. As in the embodiment of FIG. 3, a flat 89 is provided in the head 90 of the nozzle pin 85 to allow the air to flow between the pin and sleeve and exit through the clearance gap 91 and to flow over the peripheral surface 92 of the protruding tip 93. The optimum length of the nozzle pin 85 and sleeve 86 depends on the thickness of the plastics material in the thick wall section of the mould cavity.

FIG. 10 shows a different embodiment of fluid injection member in which the air flow enters the thick wall section 15 of the could cavity at the base of the thick wall section rather than at a point within the thick wall section.

In the embodiment illustrated, there is provided nozzle pin 100 combined with an ejector pin 101. The nozzle pin is machined to provide a pointed tip 102. The ejector pin 101 extends through a hole 103 in the lower part 12 of the mould tool to the base of the thick wall section. The hole 103 provides an annular passage 104 between the ejector pin and the mould tool, which is only a clearance gap 105 adjacent the thick wall section, thereby preventing back flow of plastics material. Bolted to the underside of the lower part of the mould tool there is mounted an injector cap 106 providing a connection for compressed air to flow from the air injection unit through conduit 25 to the annular passage 104. The air then flows through gap 105 into the thick wall section and upwardly, following the periphery of the nozzle pin to the nozzle tip, whereby the air forms a void 21 in the plastics material 19. The pre-packing of the plastics material in the thick wall section tends to inhibit the air from flowing around the surface of the thick wall section in a direction away from the nozzle tip.

A first O-ring 107 provides a seal between the injector cap 106 and the underside of the mould tool. A second O-ring seal 108 is provided between the injector cap and the ejector pin, which allows the ejector pin to slide up and down relative to the injector cap.

The invention is not limited to the specific details of the embodiments described above. For example, in each of the embodiments of fluid injection nozzle shown in FIGS. 3 to 9, the annular passage and/or clearance gap may be replaced by one or more longitudinal channels or slots in the nozzle pin 40; 61; 73; 85 and/or sleeve 48; 60; 74; 86 respectively to allow air or other fluid to flow therebetween, and thereby over the peripheral surface of the protruding tip of the nozzle pin. The same applies in the case of the annular passage and the clearance gap between the nozzle pin and the mould tool wall in the embodiment of FIG. 10.

In each embodiment, the process of the invention is applied in the manner described above with reference to FIGS. 1 and 2, and there is produced a plastics article without noticeable sink marks in the surface and without distortion.

1. A method of injection moulding a plastics article having thin and thick wall sections by employing a mould having a mould cavity corresponding to the shape of the article, and the mould having at least one fluid injection member extending into a portion of the mould cavity in or adjacent to the area in which a thick wall section is to be formed, the method comprising:
introducing a quantity of molten plastics material sufficient to fill the mould cavity;
introducing a further quantity of molten plastics material sufficient to pack at least the portion or portions of the mould cavity in which the thin wall section or sections are formed so that the or each thin wall section is self-supporting;
injecting pressurised fluid through the or each fluid injection member to penetrate the plastics material surrounding the inner end of the fluid injecting member whereby a fluid-filled void is formed within the plastics material adjacent to the inner end of the fluid injecting member; and
maintaining fluid pressure within the or each void so that the void expands in response to the shrinkage of the immediately surrounding plastics material, during cooling, until the plastics material is self-supporting.

2. A method as claimed in claim 1, wherein the fluid is vented from the or each void before the mould is opened to remove the article.

3. A method as claimed in claim 1 or claim 2, wherein during the step of maintaining fluid pressure within the or each void, the pressurised fluid within the respective void is maintained at its initial injection pressure.

4. A method as claimed in any one of the preceding claims, wherein the pressurised fluid is a gas, e.g. compressed air.

5. A method as claimed in any one of the preceding claims, wherein the fluid pressure is not more than 55 bar.

6. A method as claimed in any one of the preceding claims, wherein the pressurised fluid is compressed air supplied by an air intensifier.

7. Apparatus for injection moulding a plastics article having thin and thick wall sections, comprising:
a mould having a mould cavity corresponding to the shape of the article;
at least one fluid injection member extending into a portion of the mould cavity in or adjacent to the area in which a thick wall section is to be formed with its inner end positioned at a required locality within the mould cavity;
means for injecting molten plastics material into the mould cavity both to fill the mould cavity and to pack at least the portion or portions of the mould cavity in which the thin wall section or sections are formed so that the or each thin wall section is self-supporting; and
means for injecting pressurised fluid through the or each fluid injecting member to penetrate the plastics material surrounding the inner end of the fluid injection member for forming a fluid-filled void within the plastics material adjacent to the inner end of the fluid injection member, and to maintain fluid pressure within the void as it expands in response to the shrinkage of the immediately surrounding plastics material, during cooling, until the plastics material is self-supporting.

8. Apparatus as claimed in claim 7, including means for enabling the or each fluid-filled void to be vented before the mould is opened to remove the article.

9. Apparatus as claimed in claim 7 or claim 8, wherein the fluid injection member has an outer sleeve mounted in the wall of the mould, and an inner member permitting fluid to be injected into the mould cavity through a clearance gap between the inner member and the outer sleeve.

10. Apparatus as claimed in claim 9, wherein the clearance gap is sufficiently narrow to preclude the back flow of plastics material.

11. Apparatus as claimed in claim 9 or claim 10, wherein the inner member has a tip at its inner end over which the pressurised fluid is passed to assist the fluid to penetrate the skin of the surrounding plastics material.

12. Apparatus as claimed in claim 11, wherein the tip of the inner member has an inclusive acute angle of not more than 40°.

13. Apparatus as claimed in any one of claims 7 to 12, wherein the fluid injector nozzle is combined with a core pin.

14. Apparatus as claimed in any one of claims 7 to 12, including ejector pins for opening the mould.

15. Apparatus as claimed in claim 14, wherein the or at least one of the fluid injecting members is combined with one of the ejector pins, the outer sleeve of the fluid injecting member being slidably supported within the respective ejector pin.
